(19) United States
(12) Patent Application Publication
(10) Pub. No.: US 2024/0070538 A1
(43) Pub. Date: Feb. 29, 2024

(54) FEATURE INTERACTION USING ATTENTION-BASED FEATURE SELECTION

(71) Applicant: Micron Technology, Inc., Boise, ID (US)

(72) Inventors: Mritunjay Kumar, Bhagalpur (IN); Tejashri Kelhe, Pune (IN); Nidhi Nika, Sitamarhi (IN)

(21) Appl. No.: 18/237,035

(22) Filed: Aug. 23, 2023

(30) Foreign Application Priority Data
Aug. 30, 2022 (IN) 202241049482

(51) Int. Cl. G06N 20/00

(52) U.S. Cl. CPC G06N 20/00

(57) ABSTRACT

A system includes a memory and a processing device, operatively coupled to the memory, to perform operations including obtaining a set of base features associated with tabular data, selecting, from the set of base features, a set of relevant features using attention-based feature selection, wherein the set of relevant features is a subset of the set of base features, generating, from the set of relevant features using feature interaction, a set of interaction features, and generating a prediction using the set of interaction features.

### RELATED APPLICATION

This application claims priority to Indian Patent Application No. 202241049482, filed on Aug. 30, 2022 and entitled “Feature Interaction Using Attention-Based Feature Selection”, the entire contents of which are incorporated by reference herein.

### TECHNICAL FIELD

Embodiments of the disclosure relate generally to memory sub-systems, and more specifically, relate to implementing feature interaction using attention-based feature selection.

### BACKGROUND

A neural network can include an encoder network that receives raw data as input, and generates a feature representation of the raw data for a machine learning model (i.e., maps the raw data to a feature representation space). The feature representation can include a set of features. For example, the feature representation can be a feature vector. A neural network can further include a decoder network that can reconstruct the raw data from at least a portion of the feature representation (i.e., map the feature representation back into the raw data space). An encoder network and a decoder network can collectively form an encoder-decoder architecture (e.g., autoencoder). The encoder network and the decoder network can be trained to improve their ability to generate feature representations and reconstruct raw data, respectively. More specifically, the encoder network and the decoder network can be trained to reduce loss with respect to the reconstruction performed by the decoder network (e.g., using a loss function based on the difference between the actual raw data and the reconstructed raw data).

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIGS. 1A-1B are diagrams of example systems for implementing feature interaction using attention-based feature selection, in accordance with some embodiments of the present disclosure.

FIGS. 2A-2E are diagrams of example systems for implementing feature interaction using attention-based feature selection, in accordance with some embodiments of the present disclosure.

FIGS. 3A-3D are diagrams of example systems for implementing feature interaction for attention-based feature selection, in accordance with some embodiments of the present disclosure.

FIG. 4 is a flow diagram of an example method to implement feature interaction using attention-based feature selection, in accordance with some embodiments of the present disclosure.

FIG. 5 is a block diagram of an example computer system in which embodiments of the present disclosure may operate.

### DETAILED DESCRIPTION

Aspects of the present disclosure are directed to implementing feature interaction using attention-based feature selection. A set of features for constructing a machine learning model (e.g., predictive variables or predictors) can include duplicative and/or irrelevant features. Thus, such features can be removed from the set of features. Feature selection is a machine learning technique that is used to select, from the set of features, a subset of features based on their prediction ability as inputs for constructing the machine learning model. By eliminating duplicative and/or irrelevant features from the set of features, feature selection can reduce computation cost and complexity of machine learning model construction, and can improve machine learning model performance. Examples of feature selection techniques include supervised feature selection techniques, unsupervised feature selection techniques. A supervised feature selection technique can select the subset of features based on target features (e.g., for removing irrelevant features from the set of features). Examples of supervised feature selection techniques include intrinsic feature selection, wrapper feature selection, and filter feature selection. In contrast, an unsupervised feature selection technique can select the subset of features without target features (e.g., for removing duplicative features from the set of features).

It may be the case that interactions are observed to exist between combinations of features. The machine learning model can be trained to learn such interactions. For example, assume that a set of input features includes features A and B that each have a nominal individual impact on a target feature. However, the combination of A and B may be observed to have a greater impact on the target feature than the individual impacts. Feature interaction refers to a process determining respective interaction values between features of a machine learning model, and generating a set of interaction-based features from the interaction values. The set of interaction-based features can form a feature vector. Illustratively, in the case of polynomial features, each interaction-based feature can be obtained by multiplying a respective pair of features (e.g., dot product).

If the set of input features includes a small number of features, then it can be computationally practical to generate the set of interaction-based features. For example, if the set of input features includes features A, B and C and feature interactions are determined by multiplying respective pairs of features, then the set of interaction-based features can include AB, AC and BC. The feature interaction vector can include six columns, including a column for A, a column for B, a column for C, a column for AB, a column for AC and a column for BC.

However, if the set of input features includes a large number of features, then it can be computationally infeasible to generate the set of interaction-based features and feature interaction vector. For example, due to the explosion in the size of the feature space, the set of interaction-based features can utilize a sizeable amount of memory resources. To better manage the size of the feature space during feature interaction, it may be beneficial to preprocess the set of input features in a way that reduces the size of the input set of features. Some preprocessing techniques for reducing the size of an input set of features and restricting the size of the feature space, such as feature compression, can eliminate potentially important features from consideration. This can make it difficult or impossible to obtain an effective set of interaction-based features that can be learned by the machine learning model for performing a machine learning task.

Aspects of the present disclosure address the above and other deficiencies by implementing feature interaction using attention-based feature selection. Embodiments described herein can be used to reduce the number of features used to perform feature interaction for generating a set of interaction features. More specifically, a processing device can obtain a set of input features, select a set of relevant features from the set of input features using attention-based feature selection, and generate the set of interaction features from the set of relevant features.

Obtaining the set of input features can include generating the set of input features from data. In some implementations, the data includes tabular data. For example, the tabular data can include raw tabular data. Tabular data refers to data that is capable of being organized in a data structure including a number of columns and a number of rows (e.g., table). For example, tabular data can include unstructured data. The processing device can further construct a machine learning model using the set of interaction features, and perform a machine learning task using the machine learning model. For example, the processing device can generate a prediction from the set of interaction features.

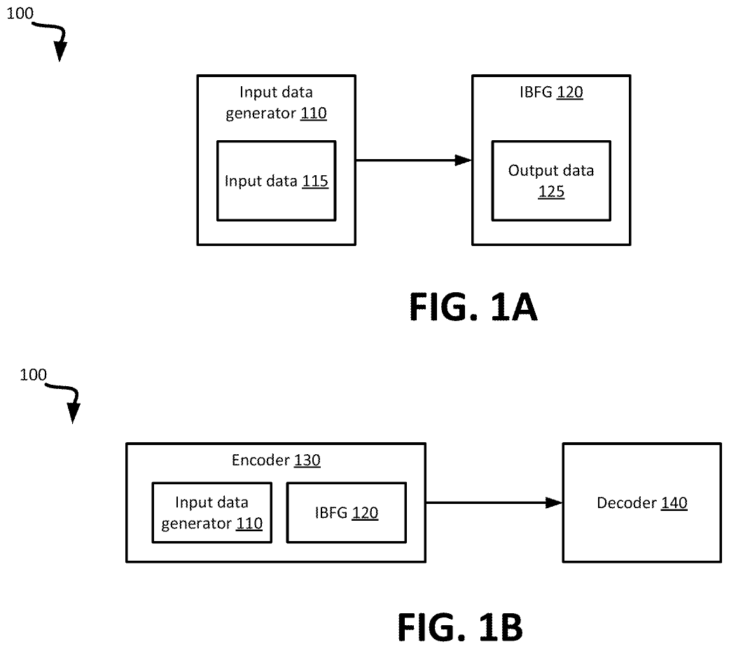

In some embodiments, feature interaction using attention-based feature selection is used for metrology. For example, embodiments described herein can be used to create interaction-based variables associated with metrology solutions for electronic device fabrication processes, such as physical vapor deposition (PVD), chemical vapor deposition (CVD), atomic layer deposition (ALD), etc. Thus, embodiments described herein can reduce the size of the feature space for generating a set of interaction-based features for metrology applications. Further details regarding implementing feature interaction using attention-based feature selection are described below with reference to FIGS. 1A-5.

Advantages of the present disclosure include, but are not limited to, improved performance and resource consumption. For example, by reducing the size of the feature space for generating the set of interaction-based features, embodiments described herein can reduce memory consumption, and can achieve greater performance than other models, such as linear models.

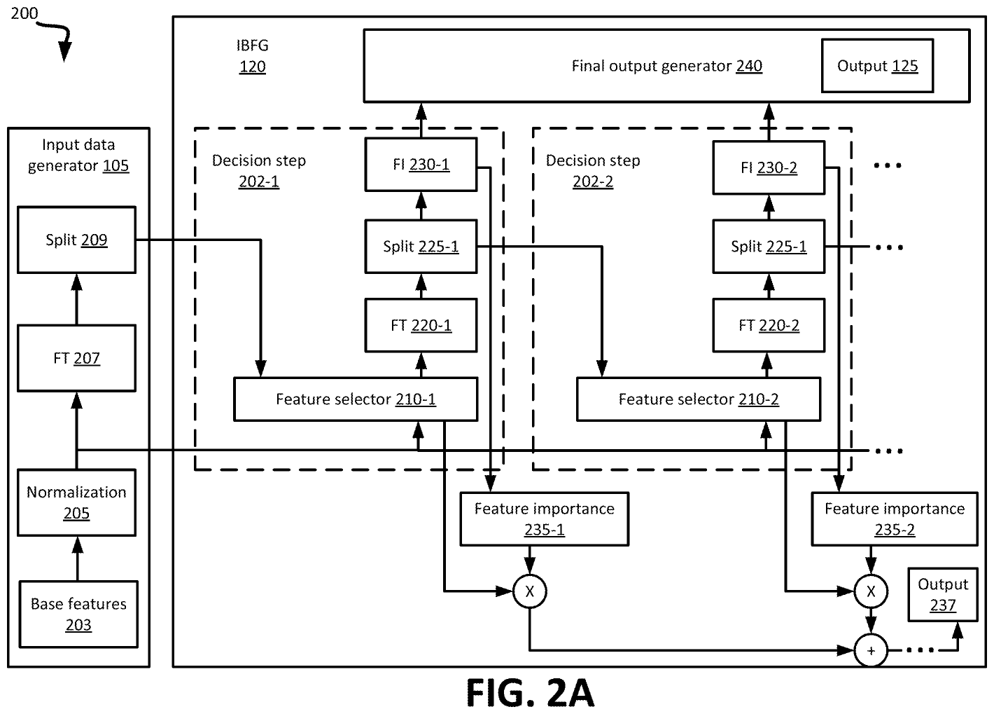

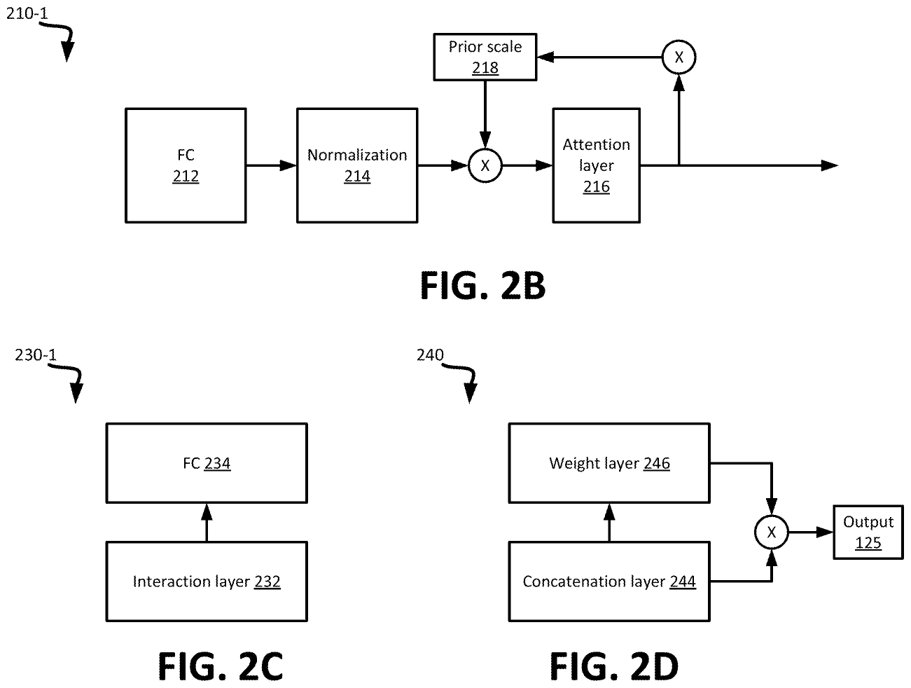

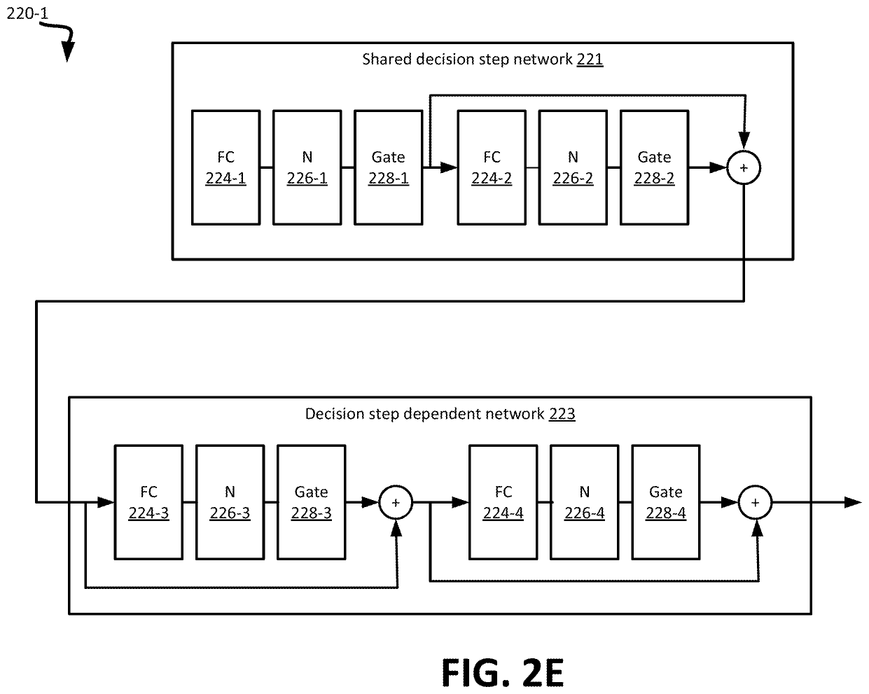

FIG. 1A is diagram of an example system 100 for implementing feature interaction using attention-based feature selection, in accordance with some embodiments of the present disclosure. As shown, the system 100 can include an input feature generator 110. The input feature generator 110 can generate a set of input features 115. In some embodiments, the set of input features 115 includes a feature vector. As will be described in further detail below with reference to FIG. 2A, the input data 115 can be generated by normalizing and transforming a set of base features.

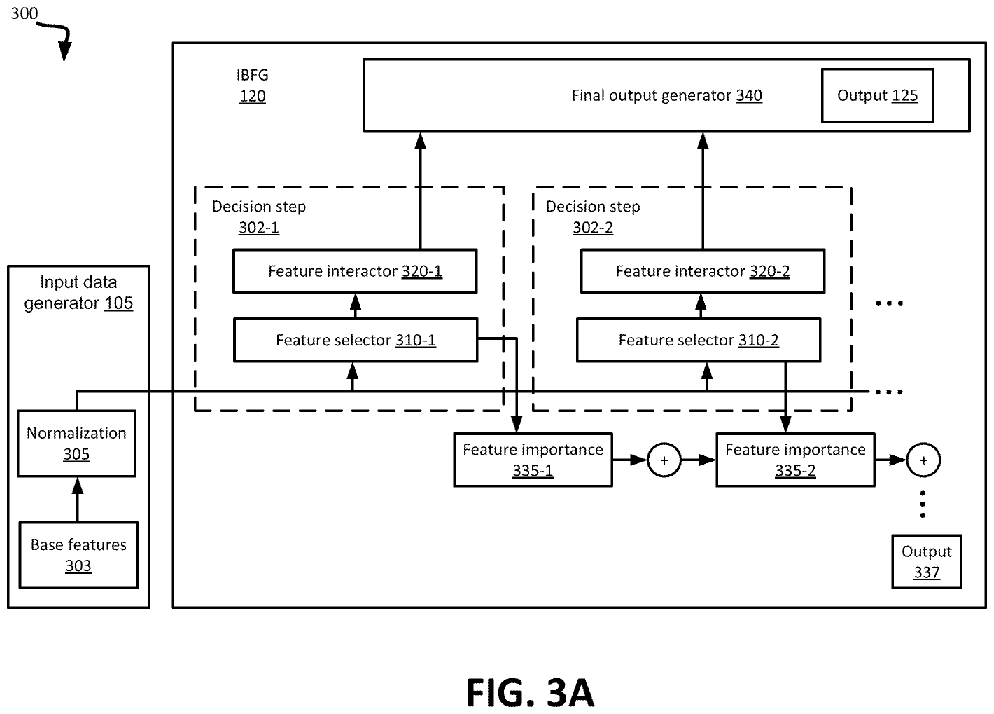

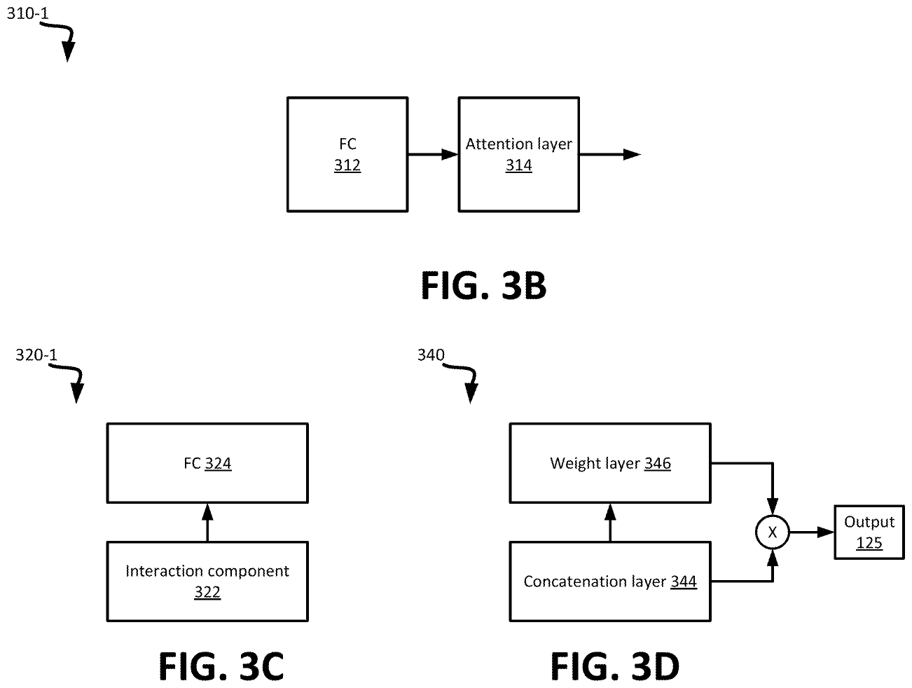

The system 100 can further include an interaction-based feature generator (IBFG) 120. The IBFG 120 can receive the set of input features 115, and generate output data 125 from the set of input features 115 using feature selection and feature interaction. For example, as will be described in further detail below with reference to FIGS. 2A-3C, generating the output data 125 can include selecting a set of relevant features from the set of input features 115 using feature selection, generating a set of interaction-based features using feature interaction, and generating the output data 125 from the set of interaction-based features.

FIG. 1B is a diagram of a high-level overview of an example system 100 implementing the IBFG 120. As shown, the system 100 can include an encoder network 130 and a decoder network 140. The encoder network 130 can include the input data generator 110 and the IBFG 120. The encoder network 130 can use the IBFG 120 to generate the output data 125, and the decoder network 140 can reconstruct a set of data from the output data 125.

FIG. 2A is a diagram of a system 200 for implementing feature interaction using attention-based feature selection, in accordance with some embodiments of the present disclosure. For example, the system 200 can be the system 100 described above with reference to FIGS. 1A-1B.

As shown, the system 200 includes the input data generator 105. In this illustrative example, the input data generator 105 can include a normalization layer 205, an initial feature transformer (FT) 207 and an initial split layer 209. As further shown, the system 200 includes the IBFG 120. As shown, the IBFG 120 can include N decision steps, including decision step 202-1 and decision step 202-2. Each decision step can include a number of components. For example, the decision step 202-1 can include a feature selector 210-1, an FT 220-1, a split layer 225-1, and a feature interactor (FI) 230-1. The decision step 202-2 can include a feature selector 210-2, an FT 220-2, a split layer 225-2, and an FI 230-2. The IBFG 120 can further include a final output generator 240. Further details regarding the functions of the components will now be described.

The input data generator 105 can receive a set of base features 203, and the set of base features 203 can be provided to the normalization layer 205 to generate an initial set of normalized features. The initial FT 207 can receive the initial set of normalized features to obtain an initial set of transformed features. The initial split layer 209 can receive the initial set of transformed features, and split the initial set of transformed features into at least one initial set of split features.

At decision step 202-1, the initial set of split features, as well as the initial set of normalized features, can be received by the feature selector 210-1 to select a set of relevant features. More specifically, the feature selector 210-1 can generate a first mask that is used to select the set of relevant features at the decision step 202-1. The set of relevant features can be provided to the split layer 225-1 to split the set of relevant features into a first set of split relevant features and a second set of split relevant features. The first set of split relevant features can be provided to the FI 230-1 to generate a first output (e.g., first output prediction), and the second set of split relevant features can be provided to the feature selector 210-2 for use at the decision step 202-2.

At decision step 202-2, the second set of split relevant features, as well as the initial set of normalized features, can be received by the feature selector 210-2 to select a set of relevant features. More specifically, the feature selector 210-2 can generate a second mask that is used to select the set of relevant features at the decision step 202-2. The set of relevant features can be provided to the split layer 225-2 to split the set of relevant features into a third set of split relevant features and a fourth set of split relevant features. The third set of split relevant features can be provided to the FI 230-2 to generate a second output (e.g., second output prediction), and the fourth set of split relevant features can be provided to the next feature selector for use at the next decision step (if applicable). Further details regarding feature transformers that can be used within the system 200 (e.g., feature transformer 220-1) will be described below with reference to FIG. 2E, further details regarding feature selectors that can be used within the system 200 (e.g., feature selector 210-1) will be described below with reference to FIG. 2B, and further details regarding feature interactors that can be used within the system 200 (e.g., FI 230-1) will be described below with reference to FIG. 2C.

In some embodiments, each individual output (e.g., first output and second output) is a prediction (e.g., probability). The output generated by the FI for each decision step (the first output generated by FI 230-1, the second output generated by FI 230-2, etc.) can be provided to the final output generator 240 to generate the output 125. More specifically, the output 125 can be a final output obtained from each of the individual outputs (e.g., the first output and the second output). For example, the output 125 can be a final output obtained as a linear combination of the individual outputs, where each individual output is multiplied by a respective weight. Further details the final output generator 240 will be described below with reference to FIG. 2D.

Moreover, the output of the feature interactor for each decision step (e.g., FI 230-1 and FI 230-2) can be received by a respective feature importance layer (e.g., feature importance 235-1 and feature importance 235-2). Each feature importance layer generates a respective feature importance (e.g., feature importance 235-1 generates a first feature importance and feature importance 235-2 generates a second feature importance). In some embodiments, each feature importance layer implements relevance aggregation, and each feature importance is a respective feature aggregation. Moreover, each mask generated by a respective feature selector can be applied to a respective feature importance to generate a respective decision step importance (e.g., the first mask can be applied to the first feature importance and the second mask can be applied to the second feature importance). Each decision step importance can be combined using an adder to obtain a final feature importance output (“output”) 237.

FIG. 2B is a diagram of an example feature selector, in accordance with some embodiments of the present disclosure. More specifically, this illustrative example refers to the feature selector 210-1 of the decision step 202-1. However, the other feature selectors of the system 200 can include similar components.

As shown, the feature selector 210-1 can include a fully-connected (FC) layer 212, a normalization layer 214 and an attention layer 216. The FC layer 212 can generate an FC layer output from the portion of the set of features received from the split component 209. The normalization layer 214 can normalize the FC layer output. The attention layer 216 can select a set of relevant features from input features. More specifically, the attention layer 216 can multiply its input by a respective learnable feature selection mask (“mask”), where the mask implements an attention mechanism. The attention mechanism can implement any suitable activation function. In some embodiments, the attention mechanism implements sparsemax. Sparsemax is similar to softmax, except that it can be used to generate sparse probabilities (e.g., probability distributions). Sparsemax can improve learning efficiency by eliminating irrelevant features. In some embodiments, and as shown, the feature selector 210-1 can further include a prior scale term 218. The prior scale term 218 indicates how much a particular feature has been used in prior decision steps. The prior scale term 218 can modulate the output of the attention layer 216.

FIG. 2C is a diagram of an example feature interactor, in accordance with some embodiments of the present disclosure. More specifically, this illustrative example refers to the FI 230-1 of the decision step 202-1. However, the other feature interactors of the system 200 can include similar components. As shown, the FI 230-1 can include an interaction layer 232 and a FC layer 234. The interaction layer 232 can receive a set of features from the split component 225-1 and generate a feature interaction from the set of features. For example, the interaction layer 232 can include a lambda layer. The interaction layer 232 can use any suitable method for feature interaction. Examples of methods for feature interaction include restricted Boltzmann machine (RMB) methods, polynomial methods, kernel methods, etc. The FC layer 234 can generate an FC layer output. The FC layer output can be provided to the final output generator 240 to generate the output 125, as will now be described in further detail below with reference to FIG. 2D.

FIG. 2D is a diagram of an example final output generator 240, in accordance with some embodiments of the present disclosure. As shown, the final output generator 240 can include a concatenation layer 244 and a weight layer 246. The concatenation layer 244 can receive each of the outputs (e.g., output predictions) of the feature interactors (e.g., FI 230-1 and FI 230-2) to generate a concatenated output. The weight layer 246 can use a weight assignment mechanism to assign, to each prediction generated from a respective step, a respective weight indicative of importance. Each prediction can be multiplied by its respective weight to obtain a respective weighted prediction. The weight layer 246 can implement any suitable activation function. In some embodiments, the attention mechanism implements softmax. The weighted predictions can be added together to generate the output 125. In other words, the output 125 can be a final prediction generated as a linear combination of each output (e.g., output prediction), wherein each term of the linear combination comprises a respective output (e.g., output prediction) multiplied by its respective weight.

Illustratively, assume that the set of base features 203 is represented by a D-dimensional feature vector f. Each decision step i∈[1, N] receives, as input, the output from the previous decision step i−1 to decide which features of the feature vectorfto select, and outputs a processed feature representation to be aggregated into the overall decision. A mask for the i-th decision step, M[i], can be used for feature selection by the IBFG of the i-th decision step. For example, M[i]=sparsemax(P[i−1]·hᵢ(a[i−1])), where P[i−1] is the prior scale term of the previous decision step i−1, a[i−1] is the processed feature representation from the previous decision step i−1, and hᵢ is the trainable function output by the normalization layer 224. The prior scale term of the i-th step can be defined as P[i]=Πⱼ₌₁ ⁱ(γ−M[j]), where γ is a relaxation parameter. The initial prior scale term, P[0], can be defined as a D-dimensional unit vector (i.e., P[0]=1^{BxD}).

FIG. 2E is a diagram of an example feature transformer, in accordance with some embodiments of the present disclosure. More specifically, this illustrative example refers to the feature transformer 220-1 of the decision step 202-1. However, the other feature transformers of the system 200 can include similar components.

As shown, the feature transformer 220 can include a shared decision step network 221 shared across all decision steps and a decision step dependent network 223 that is decision-step dependent.

The shared decision step network 221 can include a pair of sub-networks. For example, a first sub-network can include a fully connected (FC) layer 224-1, a normalization layer 226-1, and a gate layer 228-1. A second sub-network can include an FC layer 224-2, a normalization layer 226-2, and a gate layer 228-2. Moreover, the decision dependent network 223 can similarly include a pair of sub-networks. For example, a third sub-network can include an FC layer 224-3, a normalization layer 226-3, and a gate layer 228-3. A fourth sub-network can include an FC layer 224-4, a normalization layer 226-4, and a gate layer 228-4.

For example, the FC layer 224-1 can generate a first FC layer output, and the normalization layer 226-1 can normalize the first FC layer output to generate a first normalized vector. The gate layer 228-1 can act as a gating mechanism to enable a portion of data from the first normalized vector to pass through to the FC layer 224-2. More specifically, the gate layer 228-1 can generate a first gate vector from the first normalized vector. In some embodiments, the gate layer 228-1 is a gate linear unit (GLU). The FC layer 224-2 can generate a second FC layer output from the first gate vector, the normalization layer 226-2 can normalize the second FC layer output to generate a second normalized vector, and the gate layer 228-2 can generate a second gate vector from the second normalized vector. The first gate vector and the second gate vector can be combined using an adder to generate a first combined gate vector. The combination can utilize normalization to prevent substantial changes in variance, which can stabilize the learning process.

The FC layer 224-3 can generate a third FC layer output from the first combined gate vector, the normalization layer 226-3 can normalize the third FC layer output to obtain a third normalized vector, and the gate layer 228-3 can generate a third gate vector from the third normalized vector. The first combined gate vector and the third gate vector can be combined using an adder to generate a second combined gate vector. The combination can utilize normalization to prevent substantial changes in variance, which can stabilize the learning process. The FC layer 224-4 can generate a fourth FC layer output from the second combined gate vector, the normalization layer 226-4 can normalize the fourth FC layer output to generate a fourth normalized vector, and the gate layer 228-4 can generate a fourth gate vector from the fourth normalized vector. The fourth gate vector and the second combined gate vector can be combined using an adder to generate a third combined gate vector. The combination can utilize normalization to prevent substantial changes in variance, which can stabilize the learning process. The third combined gate vector can be provided to the split component 225-1, as described above with reference to FIG. 2A.

FIG. 3A is a diagram of a system 300 for implementing feature interaction using attention-based feature selection, in accordance with some embodiments of the present disclosure. For example, the system 300 can be the system 100 described above with reference to FIGS. 1A-1B.

As shown, the system 300 includes the input data generator 105. In this illustrative example, the input data generator 105 can include a normalization layer 305. As further shown, the system 300 includes the IBFG 120. As shown, the IBFG 120 can include N decision steps, including decision step 302-1 and decision step 302-2. Each decision step can include a number of components. For example, the decision step 302-1 can include a feature selector 310-1 and a feature interactor 320-1. The decision step 302-2 can include a feature selector 310-2 and a feature interactor 320-2. The IBFG 120 can further include a final output generator 340. Further details regarding the functions of the components will now be described.

The input data generator 105 can receive a set of base features 303, and the set of base features 303 can be provided to the normalization layer 305 to generate an initial set of normalized features.

At decision step 302-1, the initial set of normalized features can be received by the feature selector 310-1 to select a set of relevant features. More specifically, the feature selector 310-1 can generate a first mask that is used to select the set of relevant features at the decision step 302-1. The set of relevant features can be provided to the feature interactor 320-1 to generate a first output (e.g., first output prediction).

At decision step 302-2, the initial set of normalized features can be received by the feature selector 310-2 to select a set of relevant features. More specifically, the feature selector 310-2 can generate a second mask that is used to select the set of relevant features at the decision step 202-2. The set of relevant features can be provided to the feature interactor 320-2 to generate a second output (e.g., second output prediction), and the fourth set of split relevant features can be provided to the next feature selector for use at the next decision step (if applicable). Further details regarding feature selectors that can be used within the system 300 (e.g., feature selector 310-1) will be described below with reference to FIG. 3B, and further details regarding feature interactors that can be used within the system 300 (e.g., feature interactor 320-1) will be described below with reference to FIG. 3C.

In some embodiments, each individual output (e.g., first output and second output) is a prediction (e.g., probability). The output generated by the feature interactor for each decision step (the first output generated by feature interactor 320-1, the second output generated by feature interactor 320-2, etc.) can be provided to the final output generator 340 to generate the output 125. More specifically, the output 125 can be a final output obtained from each of the individual outputs (e.g., the first output and the second output). For example, the output 125 can be a final output obtained as a linear combination of the individual outputs, where each individual output is multiplied by a respective weight. Further details the final output generator 340 will be described below with reference to FIG. 3D.

Moreover, the output of the feature interactor for each decision step (e.g., feature interactor 320-1 and feature interactor 320-2) can be received by a respective feature importance layer (e.g., feature importance layer 335-1 and feature importance layer 335-2). Each feature importance layer generates a respective feature importance (e.g., feature importance layer 335-1 generates a first feature importance and feature importance layer 335-2 generates a second feature importance). In some embodiments, each feature importance layer implements relevance aggregation, and each feature importance is a respective feature aggregation. Moreover, each mask generated by a respective feature selector can be applied to a respective feature importance to generate a respective decision step importance (e.g., the first mask can be applied to the first feature importance and the second mask can be applied to the second feature importance). Each decision step importance can be combined using an adder to obtain a final feature importance output (“output”) 337.

FIG. 3B is a diagram of an example feature selector, in accordance with some embodiments of the present disclosure. More specifically, this illustrative example refers to the feature selector 310-1 of the decision step 302-1. However, the other feature selectors of the system 300 can include similar components.

As shown, the feature selector 310-1 can include an FC layer 312 and an attention layer 314. The FC layer 312 can generate an FC layer output from the initial set of normalized features received from the normalization layer 305. The attention layer 314 can select a set of relevant features from input features. For example, the attention layer 314 can also receive the initial set of normalized features. More specifically, the attention layer 314 can multiply its input by a respective learnable feature selection mask (“mask”), where the mask implements an attention mechanism. The attention mechanism can implement any suitable activation function. In some embodiments, the attention mechanism implements sparsemax.

FIG. 3C is a diagram of an example feature interactor, in accordance with some embodiments of the present disclosure. More specifically, this illustrative example refers to the feature interactor 320-1 of the decision step 302-1. However, the other feature interactors of the system 300 can include similar components. As shown, the feature interactor 320-1 can include an interaction layer 322 and a FC layer 324. The interaction layer 322 can receive the set of relevant features output by the feature selector 310-2 and generate a feature interaction from the set of features. The FC layer 324 can generate an FC layer output. The FC layer output can be provided to the final output generator 340 to generate the output 125, as will now be described in further detail below with reference to FIG. 3D. The interaction layer 322 can be similar to the interaction layer 232 and the FC layer 324 can be similar to the FC layer 234 described above with reference to FIG. 2C.

FIG. 3D is a diagram of an example final output generator 340, in accordance with some embodiments of the present disclosure. As shown, the final output generator 340 can include a concatenation layer 344 and a weight layer 346 to generate, from the output of each step (e.g., output prediction) an output 125 (e.g., final prediction). The concatenation layer 344 and the weight layer 346 can be similar to the concatenation layer 244 and the weight layer 246 described above with reference to FIG. 2D.

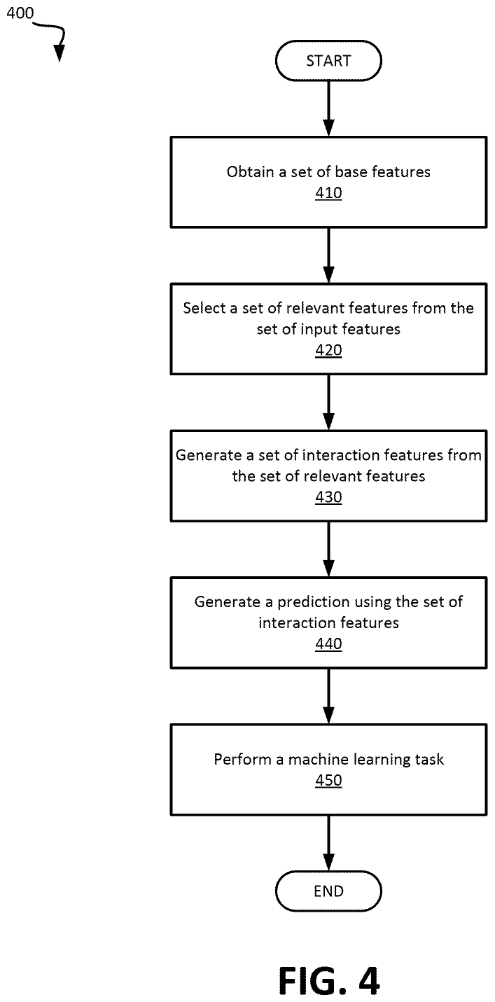

FIG. 4 is a flow diagram of an example method 400 to implement feature interaction using attention-based feature selection, in accordance with some embodiments of the present disclosure. The method 400 can be performed by control logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the interaction-based feature generator 110 of FIGS. 1A-2C. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, processing logic obtains a set of base features. More specifically, the set of base features can be associated with data. For example, obtaining the set of input features can include generating the set of input features from the data. In some implementations, the data includes tabular data. For example, the tabular data can include raw tabular data. The set of base features can be included within an input feature vector.

At operation 420, processing logic selects, from the set of base features, a set of relevant features. More specifically, the set of relevant features is a subset of the set of input features. The set of relevant features can be selected attention-based feature selection. In some embodiments, selecting the set of relevant features at operation 420 can include selecting the set of relevant features based on outputs generated by respective decision steps of a plurality of decision steps. For example, selecting the set of relevant features can include applying, for a first decision step of the plurality of decision steps, a mask generated using an attention mechanism based on an output of a second decision step of the plurality of decision steps, where the second decision step immediately precedes the first decision step. In some embodiments, the attention mechanism implements sparsemax with respect to the output of the second decision step.

At operation 430, processing logic generates a set of interaction features from the set of relevant features and, at operation 440, processing logic generates a prediction using the set of interaction features. More specifically, the set of interaction features can be generated using feature interaction. Generating the prediction can include, for each decision step, obtaining a respective decision step prediction, and generating the prediction as a linear combination of each decision step prediction. More specifically, each term of the linear combination can include a respective decision step prediction multiplied by a respective weight.

At operation 450, processing logic performs a machine learning task. In some embodiments, performing the machine learning task includes training the machine learning model based on the prediction. For example, multiple sets of training data can be used to generate multiple respective predictions, and each prediction can be used to train the machine learning model. Once the machine learning model is determined to be sufficiently trained, the machine learning model can be a trained machine learning model. Thus, the machine learning mode can be trained to obtain a trained machine learning model using tabular data.

In some embodiments, performing the machine learning task includes generating an inference prediction using a trained machine learning model. For example, performing the machine learning task can include receiving second tabular data, selecting, from the second tabular data using the trained machine learning model, a second set of relevant features using attention-based feature selection, generating, from the second set of relevant features using the trained machine learning model, a second set of interaction features using feature interaction, and generating, using the trained machine learning model, a second prediction from the second set of interaction features. Further details regarding operations 410-450 are described above with reference to FIGS. 1A-3C.

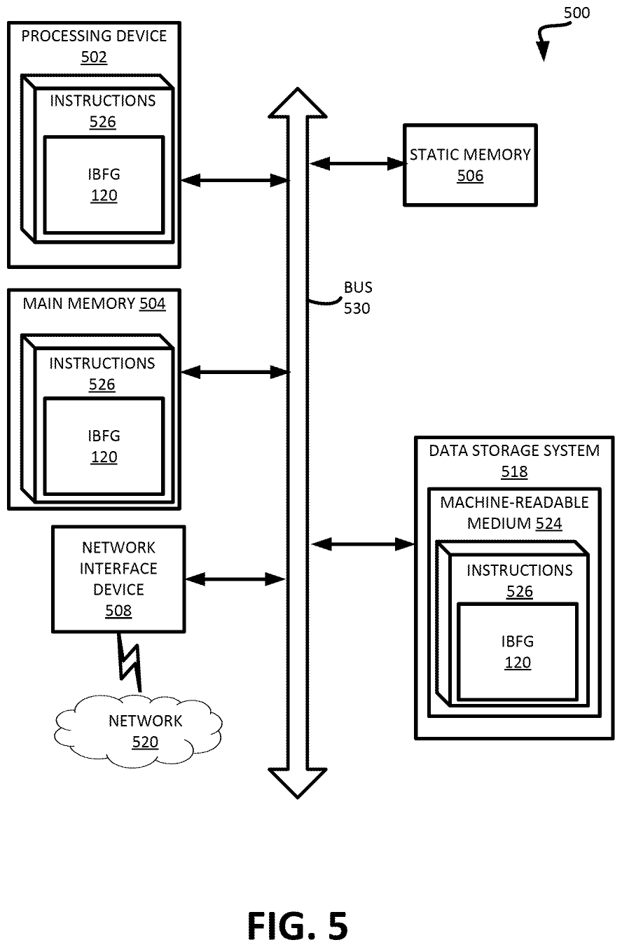

FIG. 5 illustrates an example machine of a computer system 500 within which a set of instructions, for causing the machine to perform any one or more of the methodologies discussed herein, can be executed. In some embodiments, the computer system 500 can correspond to a host system that includes, is coupled to, or utilizes a memory sub-system or can be used to perform the operations of a controller (e.g., to execute an operating system to perform operations corresponding to the IBFG 120 of FIG. 1A. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a memory cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system.

In one embodiment, the instructions 526 include instructions to implement functionality corresponding to an IBFG component (e.g., the IBFG 120 of FIG. 1A). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory; and
a processing device, operatively coupled to the memory, to perform operations comprising:
obtaining a set of base features associated with tabular data;
selecting, from the set of base features, a set of relevant features using attention-based feature selection, wherein the set of relevant features is a subset of the set of base features;
generating, from the set of relevant features using feature interaction, a set of interaction features; and
generating a prediction using the set of interaction features.

2. The system of claim 1, wherein the operations further comprise training a machine learning model based on the prediction.

3. The system of claim 1, wherein obtaining the set of base features comprises generating the set of base features from the tabular data.

4. The system of claim 1, wherein the set of relevant features is selected based on a plurality of outputs, each output of the plurality of outputs being generated by a respective decision step of a plurality of decision steps.

5. The system of claim 4, wherein selecting the set of relevant features comprises applying, for a first decision step of the plurality of decision steps, a mask generated using an attention mechanism based on an output of a second decision step of the plurality of decision steps, and wherein the second decision step immediately precedes the first decision step.

6. The system of claim 5, wherein the attention mechanism implements sparsemax with respect to the output of the second decision step.

7. The system of claim 4, wherein generating the prediction further comprises:
for each decision step, obtaining a respective output prediction; and
generating the prediction as a linear combination of each output prediction, wherein each term of the linear combination comprises a respective output prediction multiplied by a respective weight.

8. A method comprising:
obtaining, by a processing device, a set of base features associated with tabular data;
selecting, by the processing device from the set of base features, a set of relevant features using attention-based feature selection, wherein the set of relevant features is a subset of the set of base features;
generating, by the processing device from the set of relevant features using feature interaction, a set of interaction features; and
generating, by the processing device, a prediction using the set of interaction features.

9. The method of claim 8, further comprising training, by the processing device, a machine learning model based on the prediction.

10. The method of claim 8, wherein obtaining the set of base features comprises generating the set of base features from the tabular data.

11. The method of claim 8, wherein the set of relevant features is selected based on a plurality of outputs, each output of the plurality of outputs being generated by a respective decision step of a plurality of decision steps.

12. The method of claim 11, wherein selecting the set of relevant features comprises applying, for a first decision step of the plurality of decision steps, a mask generated using an attention mechanism based on an output of a second decision step of the plurality of decision steps, and wherein the second decision step immediately precedes the first decision step.

13. The method of claim 12, wherein the attention mechanism implements sparsemax with respect to the output of the second decision step.

14. The method of claim 11, wherein generating the prediction further comprises:
for each decision step, obtaining a respective output prediction; and
generating a final prediction as a linear combination of each output prediction, wherein each term of the linear combination comprises a respective output prediction multiplied by a respective weight.

15. A system comprising:
a memory; and
a processing device, operatively coupled to the memory, to perform operations comprising:
receiving data; and
generating, using a trained machine learning model, a prediction based on the data, wherein the prediction is generated using a set of interaction features, wherein the set of interaction features is generated from a set of relevant features, wherein the set of relevant features is selected from a set of features using attention-based features selection, and wherein the set of features is obtained from the data.

16. The system of claim 15, wherein the operations further comprise generating the set of base features from the data.

17. The system of claim 15, wherein the set of relevant features is selected based on a plurality of outputs, each output of the plurality of outputs being generated by a respective decision step of a plurality of decision steps.

18. The system of claim 17, wherein the operations further comprise selecting the set of relevant features by applying, for a first decision step of a plurality of decision steps, a mask generated using an attention mechanism based on an output of a second decision step of the plurality of decision steps, and wherein the second decision step immediately precedes the first decision step.

19. The system of claim 18, wherein the attention mechanism implements sparsemax with respect to the output of the second decision step.

20. The system of claim 17, wherein generating the prediction further comprises:
for each decision step, obtaining a respective output prediction; and
generating the prediction as a linear combination of each output prediction, wherein each term of the linear combination comprises a respective output prediction multiplied by a respective weight.
